(19) United States
(12) Patent Application Publication
(10) Pub. No.: US 2025/0346741 A1
(43) Pub. Date: Nov. 13, 2025

(54) ADDITIVE MANUFACTURING AND POST-TREATMENT OF INORGANIC MATERIALS

(71) Applicant: 3D Architech, Inc., Lewes, DE (US)

(72) Inventor: Kai NARITA, Cambridge, MA (US)

(21) Appl. No.: 18/869,348

(22) PCT Filed: May 30, 2023
(86) PCT No.: PCT/US2023/023862

§ 371 Date: Nov. 26, 2024

Related U.S. Application Data
(60) Provisional application No. 63/346,475, filed on May 27, 2022.

(51) Int. Cl. C08K 13/04; B29C 64/124; B33Y 10/00; B33Y 70/10

(52) U.S. Cl. CPC C08K 13/04; B29C 64/124; B33Y 10/00; B33Y 70/10; C08K 2201/014

(57) ABSTRACT

Compositions and processes for producing additively manufactured and/or thermally converted composite articles in 3D form are disclosed. The final products are optionally (i) produced by closed-loop recycling processes, (ii) achieved by electroconversion processes, (ii) i glazed prior to thermal conversion, and/or (iv) exposed to energy efficient conversion techniques, such as microwave heating and/or combustion synthesis, to promote and/or preserve nanograin or micrograin morphology.

### CROSS-REFERENCE TO RELATED APPLICATIONS

This application claims the benefit of and priority to U.S. Provisional Patent Application No. 63/346,475, filed May 27, 2022, which is hereby incorporated by reference in its entirety.

### STATEMENT REGARDING FEDERALLY SPONSORED RESEARCH None.

### BACKGROUND

Additive manufacturing (AM) creates three dimensionally designed architectures and helps to improve product performance. For example, the strength-to-weight ratio of structural components and fast charge capabilities of battery electrodes can be improved through AM.

State-of-the-art AM methods use single materials of plastics, metals, ceramics, or composites, and the materials do not change drastically during the AM process. In other words, most materials currently used for AM are synthesized1'usually as filaments, powders, or resins—before the process of creating 3D structures.

One emerging technology for the creation of 3D structures of inorganic materials is the combination of AM and thermal conversion used to manufacture metals and ceramics from organic materials such as UV-curable resins composed of metal ions and pre-ceramic polymers, respectively. Materials created by methods combining AM and thermal conversion include pure metals, alloys, ceramics, carbon, and carbon-matrix composites. At each step, the materials are limited to a certain state and/or composition. For example, materials before AM are in a liquid state, materials after AM are organic materials, and materials after thermal conversion are single materials or particulate composites. These limited material choices at each step result in a limited range of materials being produced.

### SUMMARY

Here, to overcome the limitations discussed above, compositions and methods useful for creating composites in 3D form are disclosed. Precursor materials, before AM, are composed of various materials in a liquid and/or solid state, the materials after AM can be glazed, and the conditions of thermal conversion can create 3D composites or microstructured metal structures.

Methods disclosed herein involve 1) providing a resin containing monomers or oligomers and one or more microwave susceptor materials or a precursor thereof as a liquid, slurry or solid, 2) additively manufacturing a 3D hydrogel or organogel structure from the resin of step 1), 3) swelling the 3D hydrogel or organogel structure with an aqueous solution containing a metal salt or a metal complex to form a metal-containing 3D hydrogel structure, 4) optionally, coating a glazing material on the 3D hydrogel or organogel structure from step 2) or the metal-containing 3D hydrogel structure from step 3), and 5) thermally converting the optionally glazed, 3D hydrogel or organogel structure from step 3) or step 4) to a final product. In some embodiments, step 4) is omitted.

Any of the metal-containing species in steps 1)-5) may be thermally non-reducible metal-containing species in the liquid state, thermally reducible metal-containing species in the liquid state, metal particles, metal-containing ceramic particles, metal oxide particles, inorganic particles, and/or carbon composite materials. The glazing materials in step 4) are composed of preceramic polymer and/or metal oxide particle-containing fluid. The glazed 3D structures are thermally converted into different materials depending on the atmosphere applied during the thermal conversion step 5). The combinations of materials at each step and thermal conversion conditions can create 3D architected microstructured metals, metal composites or ceramic composites with pores, optionally containing additives and/or coatings of metals, ceramics, oxides, inorganic materials and/or carbon. Such combinations are summarized in FIG. 1.

In an aspect, a resin for additive manufacturing comprises a crosslinker, a photoinitiator, a UV-blocker, and a microwave susceptor or precursor thereof.

In an embodiment, the crosslinker is poly (ethylene glycol) diacrylate, the photoinitiator is lithium phenyl-2,4,6-trimethyl benzoyl phosphinate), and the UV-blocker is tartrazine.

In an embodiment, the crosslinker is selected from the group consisting of acrylate monomer, an acrylate oligomer, a methacrylate monomer, a methacrylate monomer, a thiol monomer, a thiol oligomer, an alkene monomer, an alkene oligomer, an alkyne monomer, an alkyne oligomer, an epoxy monomer, an epoxy oligomer, an epoxy acrylate-based monomer, and an epoxy-acrylate-based oligomer.

In an embodiment, the crosslinker is selected from the group consisting of acrylic polymers, ether polymers, fluorocarbon polymers, polystyrene polymers, poly(vinyl chloride) polymers, poly(N-vinylpyrrolidone) polymers, and combinations thereof.

In an embodiment, the crosslinker is selected from the group consisting of poly(ethylene glycol) diacrylate, 1,3,5-triallyl-1,3,5-triazine-2,4,6(1H,3H,5H)-trione, and combinations thereof. In an embodiment, the crosslinker is a metal ion, such as but not limited to calcium ion.

In an embodiment, the crosslinker comprises an a carboxyl acid moiety, an amide moiety, an amine moiety, an aldehyde moiety, a ketone moiety, an ester moiety, a thiol moiety, an alkyl halide moiety, an alkoxy moiety, a hydroxyl moiety, or a phenyl moiety. For example, acrylamide crosslinkers may produce poly(acrylamide) and acrylic acid crosslinkers may produce poly(acrylic acid) after polymerization.

In an embodiment, a resin further comprises a reactive diluent selected from the group consisting of acrylamide, acrylic acid, diurethane dimethacrylate, 2-hydroxypropane-1,3-diyl bis(2-methylacrylate), vinyl acetate, poly ethylene glycol monoacrylate and methyl methacrylate.

In an embodiment, a resin comprises at least two immiscible solvents (e.g., an aqueous solvent and an organic solvent) formed into an emulsion. For example, two or more crosslinkers, photoinitiators, UV blockers, microwave susceptors, metal ions or other components to be incorporated into a 3D structure may each be soluble in different solvents, which are immiscible with one another, and the different solvents may be emulsified.

In an embodiment, the photoinitiator is selected from the group consisting of lithium phenyl-2,4,6-trimethyl benzoyl phosphinate, 2,4,6-trimethylbenzoyl-diphenylphosphineoxide, 2,2-dimethoxy-1,2-diphenyl-ethan-1-one, 1-hydroxy-cyclohexyl-phenyl-ketone, benzophenone, 2-hydroxy-2-methyl-1-phenyl-1-propanone, 2-hydroxy-1-[4-(2-hydroxyethoxy)phenyl]-2-methyl-1-propanone, methylbenzoylformate oxy-phenyl-acetic acid 2-[2 oxo-2 phenyl-acetoxy-ethoxy]-ethyl ester, oxy-phenyl-acetic 2-[2-hydroxy-ethoxy]-ethyl ester, alpha, alpha-dimethoxy-alpha-phenylacetophenone, 2-benzyl-2-(dimethylamino)-1-[4-(4-morpholinyl)phenyl]-1-butanone, 2-methyl-1-[4-(methylthio)phenyl]-2-(4-morpholinyl)-1-propanone, diphenyl (2,4,6-trimethylbenzoyl)-phosphine oxide, phosphine oxide, phenyl bis (2,4,6-trimethyl benzoyl), bis (eta 5-2,4-cyclopentadien-1-yl)bis [2,6-difluoro-3-(1H-pyrrol-1-yl) phenyl] titanium iodonium, (4-methylphenyl) [4-(2-methylpropyl), phenyl]-,hexafluorophosphate(1-), 2,2-dimethoxy-1,2-diphenylethan-1-one, isopropyl thioxanthone, 2-ethylhexyl-(4-N,N-dimethyl amino)benzoate, ethyl-4-(dimethylamino)benzoate, 2-dimethylamino-2-(4-methyl-benzyl)-1-(4-morpholin-4-yl-phenyl)-butan-1-one, azobisisobutyronitrile, benzoyl peroxide and combinations thereof.

In an embodiment, the UV-blocker is selected from the group consisting of tartrazine, benzotriazoles, benzophenones, triazines, 1-(phenyldiazenyl)naphthalen-2-ol and combinations thereof.

In an embodiment, the microwave susceptor is selected from the group consisting of a metal, a metal oxide, a metal carbide, a metal nitride, carbon and combinations thereof.

In an embodiment, a resin further comprises a metal complex or a metal salt. In an embodiment, the metal salt is a metal nitrate, a metal nitrite, a metal hydroxide, a metal chloride, a metal sulfate, a metal carbonate, a metal bicarbonate, a metal acetate, a metal fluoride, a metal bromide, a metal iodide, a metal phosphate, a metal chromate, a metal cyanide, a metal chlorate, a metal perchlorate, a metal benzoate, a metal borohydride, a metal acrylate and/or a metal sulfide.

In an embodiment, a resin comprises one or more metal acrylates; N,N-dimethylformamide; dimethyl sulfoxide; isopropanol; methanol; glycerol; ethanol; or combinations thereof.

In an aspect, an additive manufacturing and thermal conversion process comprises additively manufacturing a 3D structure by photopolymerizing a resin disclosed herein and thermally converting the 3D structure into a final product via microwave heating. For example, a 3D structure may be exposed to microwave heating for 5 seconds to 15 minutes, or from 10 seconds to 10 minutes, or from 30 seconds to 5minutes. In an embodiment, the 3D structures reach temperatures greater than 400° C. or greater than 450° C. or greater than 500° C. during the microwave heating. At these temperatures, polymer (resin) is decomposed converting metal-containing resin into metal-containing materials without resin.

In an embodiment, the additive manufacturing and thermal conversion process further comprises swelling the 3D structure using an aqueous metal salt solution to form a metal-containing hydrogel. In an embodiment, the process further comprises electrochemically introducing metals into the 3D structure. For example, the step of electrochemically introducing may include plating, converting, reducing or depositing the metals onto or into the 3D structure.

In an embodiment, the 3D structure is a microwave susceptor-containing organogel, a microwave susceptor precursor-containing organogel, a microwave susceptor-containing hydrogel or a microwave susceptor precursor-containing hydrogel.

In an embodiment, the additive manufacturing and thermal conversion process further comprises coating a glazing material on the 3D structure prior to thermally converting. For example, the glazing material may comprise a preceramic polymer, a metal oxide particle-containing fluid, or a glass precursor. For example, a precursor of a glazing material may comprise an element selected from the group consisting of magnesium, aluminum, silicon, and combinations thereof.

In an embodiment, the additive manufacturing and thermal conversion process further comprises exposing the 3D structure to a reducing atmosphere, an oxidizing atmosphere and/or an inert atmosphere during the step of thermally converting.

In an embodiment, the final product is porous and/or a lattice. In an embodiment, the final product comprises nano-grains or microstructure, such as micro-grains or twinning.

In an aspect, an additive manufacturing and thermal conversion process comprises preparing a resin; incorporating metals, ceramics, metal oxides, carbon, and/or precursors thereof into the resin; printing the resin to form an additively manufactured article; and thermally converting the additively manufactured article into a final composite product.

In an embodiment, the step of incorporating metals, ceramics, metal oxides, carbon, and/or precursors thereof into the resin comprises mixing a metal-containing solution with the resin prior to printing and/or swelling a metal-containing solution into the resin after establishing a predetermined 3D structure.

In an embodiment, the step of incorporating metals, ceramics, metal oxides, carbon, and/or precursors thereof into the matrix comprises electrochemically introducing metals into the resin after establishing a predetermined 3D structure.

In an embodiment, the step of thermally converting the additively manufactured article comprises generating heat from one or more of an external heat source, microwave energy, and a combustion synthesis reaction.

### BRIEF DESCRIPTION OF THE DRAWINGS

Illustrative embodiments of the present invention are described in detail below with reference to the attached drawings, wherein:

FIG. 1 is a summary of pathways from precursor materials to final materials through AM and thermal conversion steps to create 3D composites, according to multiple embodiments.

FIG. 2 illustrates steps of recycling and 3D printing metal-containing resins, according to an embodiment.

FIG. 3 illustrates steps of 3D printing “blank” resin and swelling recycled metal solution into the resin, according to an embodiment.

FIG. 4 shows a recycling process used to create 3D metal-containing objects, according to an embodiment.

FIG. 5 illustrates pathways from a slurry comprising metal-ion containing resin to final materials, according to some embodiments.

FIG. 6 illustrates pathways from a slurry comprising organic resin to final materials, according to some embodiments.

FIG. 7 illustrates an electrochemical reduction-based conversion process with simultaneous ion swelling, according to an embodiment.

FIG. 8 illustrates an electrochemical reduction-based conversion process with simultaneous ion swelling, according to an embodiment.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

As used herein, a “moiety” is a part of a molecule.

As used herein, a “crosslinker” is a molecule that chemically reacts with and covalently joins oligomers and/or polymers.

The term “hydrogel” refers to a material comprising a network of one or more polymers, typically one or more hydrophilic polymers, and comprising water. A hydrogel usually comprises a water content selected from the range of 1 wt. % to 90 wt. % or 10 wt. % to 90 wt. %.

As used herein, the term “organogel” refers to a material comprising a network of one or more polymers, typically one or more hydrophilic polymers, and comprising a water-miscible non-water solvent. An organogel usually comprises a water-miscible non-water solvent content selected from the range of 1 wt. % to 90 wt. % or 10 wt. % to 90 wt. %.

As used herein, “swelling”, “swelling-in”, or “swell-in” refers to a first material, such as a resin, hydrogel, organogel or other composition, taking up at least one other material and/or chemical species (e.g., element, molecule, metal ion(s)) such that the at least one other material and/or chemical species become a part of or interspersed/dispersed within the first material. Exemplary swelling techniques include but are not limited to immersing, injecting, spraying, fumigating or otherwise contacting the first material with a solution comprising the at least one other material and/or chemical species to be absorbed into or adsorbed onto the first material.

As used herein, “microwave susceptor” refers to an atom, a molecule, or a complex that reflects or absorbs energy in the microwave portion of the electromagnetic spectrum, thereby producing an amount of heat at least partially determined by microwave penetration depth and loss tangent factor. Neat forms of microwave susceptors are solids at room temperature characterized by a penetration depth less than 1 meter and/or a loss tangent factor greater than 0.1. Examples of microwave susceptors include but are not limited to metals (e.g., aluminum, copper, silver, gold, zirconium, silicon), metal oxides, metal carbides (e.g., silicon carbide), carbon nanotubes, carbon black, graphite, graphitized carbon powder, and hard carbon powder.

As used herein, “additive manufacturing” refers to a manufacturing process that produces a three-dimensional object by adding raw material to a partial structure to form a final product made of the raw material. Exemplary additive manufacturing processes include but are not limited to 3D printing, stereolithography, vat polymerization, jet printing, atomic layer deposition, and material extrusion.

In contrast to additive manufacturing, “subtractive manufacturing” refers to a manufacturing process that produces a three-dimensional object by removing a portion of raw material from a workpiece to form a final product made of the raw material. Exemplary subtractive manufacturing processes include but are not limited to grinding, milling, lathing, carving, etching, and Computer Numerical Control (CNC) machining.

“Proximal” and “distal” refer to the relative positions of two or more objects, planes or surfaces. For example, an object that is closer in space to a reference point relative to the position of another object is considered proximal to the reference point, whereas an object that is further away in space from a reference point relative to the position of another object is considered distal to the reference point.

The terms “direct and indirect” describe the actions or physical positions of one object relative to another object. For example, an object that “directly” acts upon or touches another object does so without intervention from an intermediary. Contrarily, an object that “indirectly” acts upon or touches another object does so through an intermediary (e.g., a third component).

The term “metal-containing species” refers to a chemical species (e.g., atom, salt, ion, compound, molecule, material) whose chemical formula includes at least one metal element. For example, a material, object, chemical species, compound, molecule, mixture, solution, or dispersion that is characterized or referred to as “metal-containing” is a material, object, chemical species, compound, molecule, mixture, solution, or dispersion, respectively, that comprises at least one metal and/or metal-containing species. The term “metal-containing material” refers to a material that includes at least one metal and/or metal-containing species. The term “metal-containing hydrogel” refers to a hydrogel that includes at least one metal and/or metal-containing species. The term “metal-containing particles” refers to particles that comprise at least one metal and/or metal-containing species (e.g., metal oxide or metal nanoparticles). A metal-containing material may include one or more metal atoms and/or metal ions involved in ionic, covalent, metallic, and/or coordination bonding of the material.

The term “metal element” refers to a metal element of the periodic table of elements. In addition, as used herein, the term “metal” includes elements that are metalloids. Metalloid elements include B, Si, Ge, As, Sb, and Te, and optionally, Po, At, and Se.

The term “metal alloy” refers to an alloy of two or more metals. For example, a metal alloy may be characterized as a solid solution of two or more metal elements (e.g., the metal elements being in the form of atoms or ions in the solid solution), a mixture of metallic phases, or an intermetallic compound. A metal alloy can be characterized as comprising metallic bonding. In certain embodiments, a metal, rather than a metal alloy, refers to a metallic material whose chemical formula has one metal element (i.e., its compositions has one metal element).

The term “ceramic” refers to a solid material comprising a compound of metal, non-metal, and/or metalloid atoms that are ionically and/or covalently bonded. For example, a ceramic material can be characterized as having cations (e.g., metal ions, which can be metalloid ions) and anions (e.g., oxygen ions, nitrogen ions, carbide ions) that are ionically and/or covalently bonded to one another.

As used herein, the term “blank” refers to an additively manufactured 3D structure devoid of metal-containing species, which may be added in a subsequent step (e.g., via swell-in, diffusion, absorption, adsorption and/or glazing).

As used herein, a “resin” refers to a mixture that comprises crosslinkers, such as monomers, macromolecules, and/or polymers. As used herein, a photoresin is a resin comprising one or more photoinitiators.

The term “architected” refers to a system, structure, geometry, or feature having features that are designed and formed according to the design. In an embodiment, an architected structure is deterministic or formed according to deterministic process(es). In an embodiment, features, and physical dimensions thereof, are designed, or pre-determined, and formed according to the design such that the features, and physical dimensions thereof, are equivalent to those of the design. As used herein, an architected metal-containing material is a nano-or micro-architected material (having a nano-or micro-architected structure).

As used herein, “net-shaped” refers to an object, such as a precursor to a final product, that has a size and/or shape similar to a planned size and/or shape of the final product. For example, a net-shaped precursor of an additively manufactured 3D structure disclosed herein may have the same shape as the final product obtained after thermal treatment. In some embodiments, a net-shaped precursor of an additively manufactured 3D structure may have a size that is 200%, or 100%, or 50%, or 25%, or 10%, or 5% larger than the final product obtained after thermal treatment (e.g., after removal of liquid and resin).

### Additive Manufacturing and Thermal Conversion to Create Three-Dimensionally Architected Composites

As discussed above, methods disclosed herein involve 1) incorporating metals, ceramics, carbon, and/or their precursors as a liquid or solid into metal-containing resin, 2) additive manufacturing using the metal-containing resin, 3) coating glazing materials on the printed metal-containing resin from step 2), and 4) thermally converting the glazed, metal-containing resin from step 3) to the desired final products of those composites. In an embodiment, step 3) can be omitted.

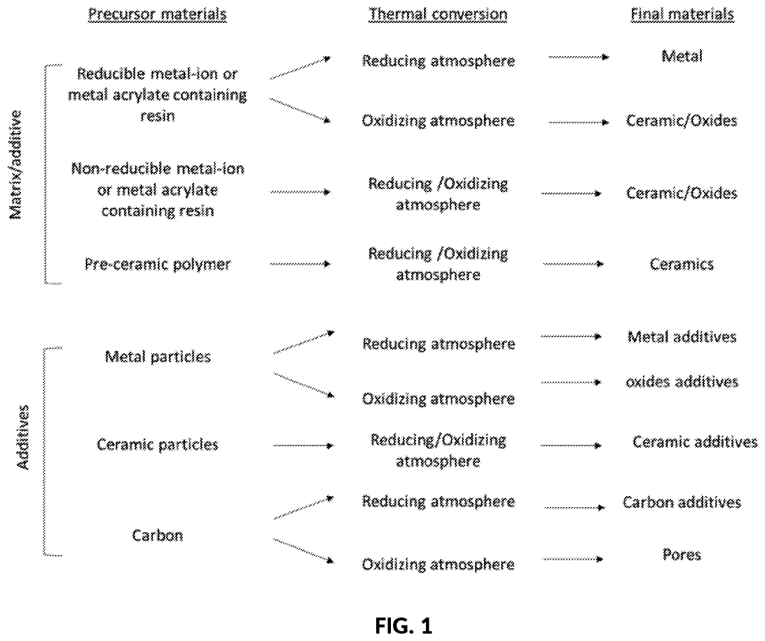

The materials in step 1), functioning as a matrix in the final composite products, are composed of thermally non-reducible metal-containing resin in the liquid state, thermally reducible metal-containing resin in the liquid state, and/or preceramic polymer in the liquid state. The materials in step 1) may further comprise metal particles, ceramics particles, metal oxide particles, and/or carbon materials. The glazing materials are composed of preceramic polymer or metal oxide particle-containing fluid. The glazed 3D architected precursors are thermally converted into different materials depending on the atmosphere applied during the thermal conversion step 4). The combinations of materials at each step and thermal conversion conditions can create 3D architected metal-matrix composites or ceramic-matrix composites with pores, optionally containing additives and/or coatings of metals, ceramics, oxides, and/or carbon. Such combinations are summarized in FIG. 1, which is a summary of pathways from precursor materials to final materials through additive manufacturing and thermal conversion steps to create 3D architected composites, according to multiple embodiments.

In some embodiments, an aqueous photoresin containing dissolved metal salts, water, water-soluble crosslinkers, and photoactive molecules is used to print a metal-salt containing hydrogel. This is referred to as a “salt-in” process.

In a “swell-in” approach, metal salts are swollen into a hydrophilic polymer. This can be done using an aqueous photoresin or an organic photoresin that contains a water-miscible organic solvent.

Advantages of the processes disclosed herein include, but are not limited to:
any water-soluble metal salt can be used, resulting in a wide variety of metal oxides that can be produced from thermal treatment in air;
metal oxides, which are produced from metal salts (microwave susceptor precursors) or introduced directly into the resin, may serve as microwave susceptors that promote microwave heating, which is faster and more energy efficient than traditional heating methods;
fast microwave heating, and in some embodiments, combustion synthesis, suppresses grain growth, which is beneficial for heterogeneous nucleation and maximizes the potential of creating 3D materials comprising nano-grains, micro-grains, or twinning;
introduction of metal or metal oxide particles into the resin decreases shrinkage during thermal treatment.
under the appropriate reducing condition (temperature, thermal-treatment atmosphere, reagent), metal oxides can be reduced to metals;
electrochemical reduction may be used to skip the above-mentioned reduction step;
if complex oxides (e.g., ternary oxides) were the starting materials, alloys can be produced; and/or
glazing enables multi-materials before or after thermal processing.

Examples of AM and thermal conversion processes producing 3D architected materials follow. These Examples are for illustrative purposes only and are not intended to limit the invention.

As a general overview, in an embodiment, microwave heating causes the temperature of a hydrogel containing metal ion(s) to release water and form metal oxide at about 150-250° C. The fully or partially dried hydrogel containing metal oxide is further microwave heated to greater than about 500° C., which decomposes the hydrogel resin into gas(es) (e.g., CO₂, NOₓ) that disperse leaving only metal oxide. The entire conversion occurs in about 3 minutes (e.g., more than 1 minute and less than 10 minutes) with very uniform heating. In contrast, conventional heating methods, such as heating with a tube furnace, require more than 48 hours at a slow heating rate to achieve uniform heating.

### EXAMPLE 1

This Example illustrates the creation of metal-matrix glass-particulate composites by additive manufacturing of metal-ion containing aqueous resin and multiple metal-containing organic resins formed into an emulsion, and thermal conversion in a reducing atmosphere.

A metal-ion containing aqueous resin is prepared by mixing crosslinkers (e.g. poly(ethylene glycol) diacrylate, photoinitiators (e.g., lithium phenyl-2,4,6-trimethyl benzoyl phosphinate), UV-blockers (e.g., tartrazine), water, and metal salt (e.g., metal nitrate). Then, the metal-ion containing aqueous resin is formed into an emulsion with organic resin comprising multiple metal acrylates, photoinitiators, UV-blockers, crosslinkers, and surfactants. The metal-ions in the emulsion include metal ions that are non-reduceable by heat treatment in hydrogen-containing atmosphere such as magnesium, aluminum, and silicon.

The emulsion is 3D printed by a lithography-based 3D printer (e.g., LCD 3D printer). The printed resin is thermally converted to a metal-matrix glass-particulate composite at high temperature (600° C. to 1000° C.) in an inert atmosphere or reducing gases (e.g., ammonia and hydrogen) to accelerate the reduction process to metals/alloys. The obtained 3D structured composite comprises metal-matrix with glass additives.

### EXAMPLE 2

This Example illustrates creation of ceramic/metal composites by AM of a mixed resin of preceramic polymer and metal acrylate containing resin, and thermal conversion in a reducing atmosphere.

A metal-ion containing organic resin is prepared by mixing crosslinkers (e.g. poly(ethylene glycol) diacrylate), photoinitiators (e.g., lithium phenyl-2,4,6-trimethyl benzoyl phosphinate), UV-blockers (e.g., tartrazine), and metal acrylate, and then blending with preceramic polymer resin.

The metal-ion containing organic resin with a preceramic polymer resin is 3D printed by a lithography-based 3D printer (e.g., LCD 3D printer). The printed resin is thermally converted to ceramic-metal composite at high temperature (600° C. to 2000° C.) in an inert atmosphere or reducing gases (e.g., ammonia and hydrogen) to accelerate the reduction process to metals/alloys. The obtained 3D structured composite comprises metals and ceramics.

### EXAMPLE 3

This Example illustrates creation of composites of dissimilar metals by AM of a metal-ion containing resin with dissimilar metal/metal oxide particles, and thermal conversion in a reducing atmosphere.

A metal-ion containing aqueous resin is prepared by mixing crosslinkers (e.g. poly(ethylene glycol) diacrylate), photoinitiators (e.g., lithium phenyl-2,4,6-trimethyl benzoyl phosphinate), UV-blockers (e.g., tartrazine), water, and metal salt (e.g., metal nitrate). Then, the metal-ion containing resin is mixed with metal particles or metal oxide particles that can be reduced in a reducing atmosphere, such as oxides of iron, copper, cobalt, nickel, and silver.

The metal-ion containing aqueous resin with metal or metal oxide particles is 3D printed by a lithography-based 3D printer (e.g., LCD 3D printer). The printed resin is thermally converted to dissimilar metal composites at high temperature (600° C. to 1000° C.) in an inert atmosphere or reducing gases (e.g., ammonia and hydrogen) to accelerate the reduction process to metals/alloys. The obtained 3D structured composite comprises dissimilar metals. Such composites exhibit high structural integrity, and are especially useful for tall objects and avoidance of shrinkage.

### EXAMPLE 4

This Example illustrates creation of composites of silver with glass coating by additive manufacturing of the silver ion-containing resin and coating with a glaze material, and thermal conversion in air.

A silver-ion containing aqueous resin is prepared by mixing crosslinkers (e.g. poly(ethylene glycol) diacrylate), photoinitiators (e.g., lithium phenyl-2,4,6-trimethyl benzoyl phosphinate), UV-blockers (e.g., tartrazine), water, and silver salt (e.g., silver nitrate). Then, the silver ion containing aqueous resin is 3D printed by a lithography-based 3D printer (e.g., LCD 3D printer).

The printed resin is then coated by glazing materials comprising oxide, silica, water, and/or metals. The glazed 3D resin is thermally converted to silver with a glass coating at high temperature (600° C. to 1000° C.) in air.

Additive Manufacturing with Microwave-Assisted and Solution Combustion Synthesis

Traditional thermal conversion processes impact gas formation, nucleation, and growth of inorganic materials, with sintering requiring slow heating rates of 0.5° C.-2° C./min to enable uniform shrinkage of 3D architected structures. In addition, the thermal conversion process is conducted by an electric furnace using external heating elements, which is an energy-intensive process.

Here, to overcome drawbacks of the traditionally slow and energy-intensive thermal conversion process, methods for making the thermal conversion process faster and more efficient using microwave-assisted heating and solution combustion synthesis are disclosed. These methods improve the rate-limiting and most expensive step in metal-based AM. Also, the fast heating process suppresses grain growth, which is beneficial for heterogeneous nucleation in the resin and maximizes the potential of creating 3D architected materials comprising nano-grains and/or microstructure.

The disclosed thermal conversion method includes 1) providing an organic resin comprising a strong oxidizer, such as nitrate, to cause an auto-catalyzed combustion reaction, 2) microwave-heating of liquid and organic materials before the conversion, and 3) microwave-heating of oxide and metal materials after conversion. Resin(s) in step 1), functioning as a precursor(s) for the microwave-assisted thermal conversion process, are composed of metal/ceramic precursors, nano/micro particles of microwave susceptor materials, precursors of microwave susceptor materials (e.g., metal-containing organic resin), oxidizer to cause combustion synthesis, and/or UV-curable resin materials for lithography-based additive manufacturing and extrudable materials for extrusion-based additive manufacturing. During stops 2) and 3), microwave energy heats the resin and microwave susceptor materials; once the combustion synthesis by oxidizer is triggered, the auto-catalyzed combustion synthesis increases temperatures and forms inorganic material, accelerating microwave heating. The combination of microwave combustion synthesis and increasing the microwave absorbing materials enables rapid sintering and shortens the thermal conversion time, thereby saving energy. External heat sources can be used to accelerate the heating process. The atmosphere can be controlled depending on the target final materials. Taking advantage of the rapid heating process and heterogeneous nucleation of self-standing 3D architected precursors, the process is capable of creating non-conventional microstructures of materials such as nano-grain or amorphous microstructures.

Examples of AM with microwave-assisted and solution combustion synthesis follow. These Examples are for illustrative purposes only and are not intended to limit the invention.

### EXAMPLE 5

This Example illustrates microwave-assisted heating of a 3D architected resin comprising UV-curable hydrogel, nickel nitrate salts, and SiC nanoparticles.

A resin or UV-curable hydrogel for microwave-assisted heating is prepared by mixing crosslinkers (e.g., poly(ethylene glycol) diacrylate), photoinitiators (e.g., lithium phenyl-2,4,6-trimethyl benzoyl phosphinate), UV-blockers (e.g., tartrazine), water, and nickel nitrate. Then, the UV-curable hydrogel is mixed with SiC nanoparticles functioning as microwave susceptor particles.

The nickel nitrate-containing hydrogel resin with SiC nanoparticles is 3D printed by a lithography-based 3D printer (e.g., LCD 3D printer). The thermal conversion process is achieved by microwave heating, where microwaves are absorbed by water and SiC nanoparticles, and drying the free-standing hydrogel. Once the temperature reaches the combustion synthesis temperature, the combustion synthesis occurs and forms nickel oxide with heterogenous nucleation. Then nickel oxide functions as a microwave susceptor, and microwave sintering can be achieved. The final materials are 3D architected nickel oxide-matrix composites with SiC nanoparticle additives.

### EXAMPLE 6

This Example illustrates microwave-assisted heating with an external heating source under a reducing atmosphere for a 3D architected resin comprising UV-curable hydrogel, copper nitrate salts, and preceramic polymer.

A resin for microwave-assisted heating is prepared by mixing crosslinkers (e.g., poly(ethylene glycol) diacrylate), photoinitiators (e.g., lithium phenyl-2,4,6-trimethyl benzoyl phosphinate), UV-blockers (e.g., tartrazine), water, and copper nitrate. Then, the UV-curable hydrogel is mixed with preceramic polymer functioning as a microwave susceptor precursor.

The prepared resin is 3D printed by a lithography-based 3D printer (e.g., LCD 3D printer). The thermal conversion process is conducted using microwave heating and an external heating source, such as an electric furnace. The microwave heating and external heating dries the 3D architected free-standing resins and causes combustion synthesis, leading to the formation of silicon carbide and copper oxide, which function as microwave susceptors. Under a reducing atmosphere, such as a forming gas (90% N₂ and 10% H₂), the accelerated heating by those microwave susceptors can reduce copper oxide to copper and achieve microwave-assisted sintering. The shortened sintering time with SIC, which may function to suppress grain growth, can achieve a nanograin microstructure of copper matrix. The final materials are 3D architected copper-matrix composites with silicon carbide-based additives.

### Recycling Metal-Containing Materials for Additive Manufacturing

Additive manufacturing is a process that produces three-dimensionally architected products with minimal waste in contrast to traditional subtractive manufacturing such as machining and cutting. Additively manufactured products have been adopted in our societies from our home products to industrial-scale products, such as the automotive engine.

After end-of-life for these products, an ideal solution for achieving closed loop product-to-product manufacturing with minimal waste is to recycle these products for the materials that can be used again by AM to create controlled form factors and material compositions. State-of-the-art recycling processes involving AM mainly focus on extrusion-based AM. For instance, the recycling of powder residue produced in selective laser sintering processes has been explored for creating composite filaments for extrusion-based AM. In addition, although recycling has been established in traditional manufacturing processes, controlling form factors of products with desired material compositions of recycled materials requires an economically and energetically expensive process to remove impurities and improve formability.

Here, a recycling process that overcomes the challenges discussed above and can be adopted for gel-enabled metal/ceramic AM is disclosed. Gel-enabled metal/ceramic AM is a process that 3D-prints metal-ion-containing gels by lithography-based 3D printing (e.g., LCD 3D print, SLA 3D print, and DLP 3D print) and thermally converts these gels to metals/alloys or ceramics with micron-scale resolutions.

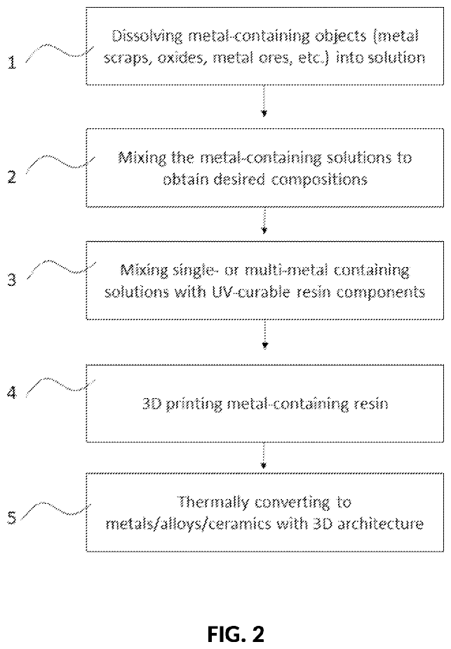

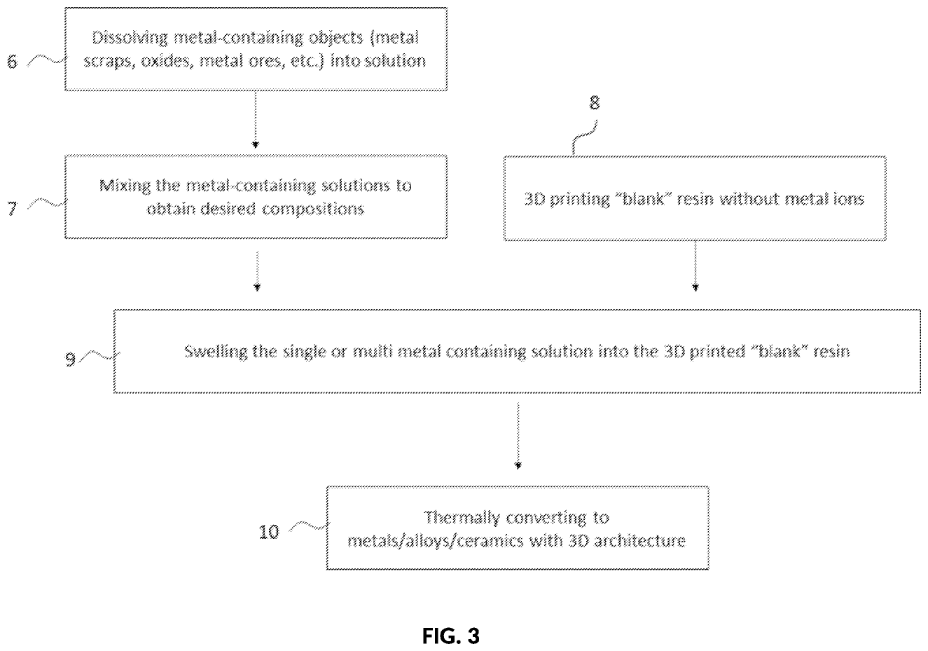

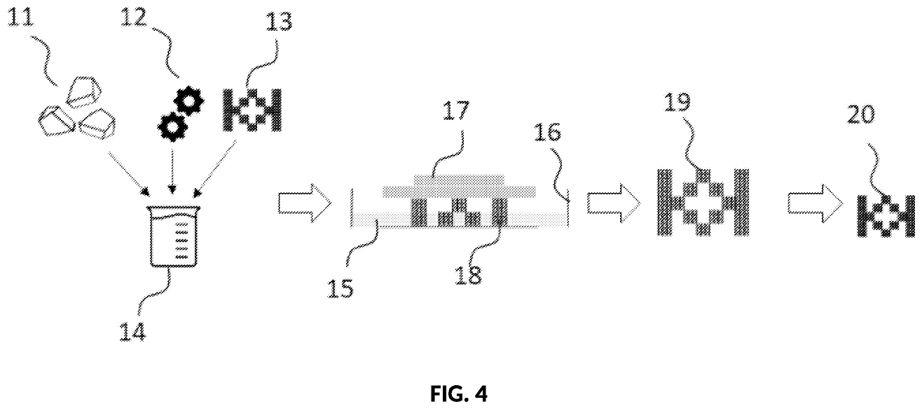

FIGS. 2-4 show methods for recycling and forming final products with desired compositions and architectures through different routes. Metal-containing objects including but not limited to metal scraps, metal ores, oxides, 3D printed metal-containing objects and the like, can be recycled by chemically dissolving them into solution (FIG. 2—step 1). The dissolving solution includes but is not limited to hydrochloric acid, nitric acid, sulfuric acid, alkoxides, acetic acid, and combinations thereof. The metal-containing solutions are then mixed, if desired, to achieve target final metal/ceramic compositions (FIG. 2—step 2). Once a solution with a desired composition is obtained, the solution is blended with crosslinkers, photoinitiators, UV-blockers, and other compounds to obtain UV-curable gel for a 3D printing or other AM process (FIG. 2—step 3). The process of mixing metal-containing solutions can be conducted after producing “blank” resin that is composed of the aforementioned chemicals except for the metal-containing solutions (i.e., crosslinkers, photoinitiators, and UV-blockers) (FIG. 3—step 8). The “blank” resin is then additively manufactured and the metal-containing solution can be swelled into the “blank” resin (FIG. 3—step 9). The metal-containing 3D resin is then thermally converted to 3D architected metals/alloys/ceramic (FIG. 2—step 5 or FIG. 3—step 10). In the present approach, the mixing process to achieve desired compositions is conducted at low temperatures (e.g., room temperature) which is energetically beneficial in contrast to pyrometallurgical routes. In addition, the present approach does not undergo metalworking (e.g., bending, machining, and welding) but is AM in the gel-form, which allows for recycled materials to be arbitrarily shaped with nano-/micron-scale resolution, not feasible by conventional recycling processes. FIG. 4 illustrates the disclosed method, where a recycling process is used to create 3D architected metal-containing objects. Iron ore-derived materials 11, metal scraps 12, and/or 3D printed metal-containing objects 13 are dissolved into solution 14. The metal-containing solution with UV-curable resin 15 in a resin tray 16 is 3D printed on buildhead 17, creating a 3D printed object 18. The entirely printed object 19 is then thermally converted into metals/alloys/ceramics having a 3D architecture 20.

Examples of recycling metal-containing materials for additive manufacturing follow. These Examples are for illustrative purposes only and are not intended to limit the invention.

### EXAMPLE 7

This Example illustrates recycling iron or copper scraps to form iron-or copper-containing 3D architectures.

Iron or copper scraps are dissolved by a nitric acid solution to create an iron-or copper-containing solution at room temperature. A solution that contains other metals, such as alloying elements like cobalt, manganese, and chromium, can be prepared by dissolving metals or oxides in nitric acid. These metal-containing solutions are mixed with each other to obtain desired compositions, then used to create UV-curable resins by blending with crosslinkers (e.g., poly(ethylene glycol) diacrylate), photoinitiators (e.g., lithium phenyl-2,4,6-trimethyl benzoyl phosphinate), and UV-blockers (e.g., tartrazine). Then, the metal-containing UV-curable resin is 3D printed by an LCD 3D printer. The printed resin is thermally converted to metals/alloys at high temperatures (600° C. to 1000° C.) in an inert atmosphere or reducing atmosphere (e.g., ammonia and hydrogen) to accelerate the reduction process to metals/alloys. The obtained 3D structured object is composed of iron, copper, iron alloys, copper alloys, iron-based oxides, copper-based oxides or a combination of these.

### EXAMPLE 8

This Example illustrates forming copper/copper alloys with 3D form factors from copper oxides.

Copper scraps or copper oxides extracted from copper ores are dissolved by a nitric acid solution to create a copper-containing solution at room temperature. A solution that contains other metals used for alloying can be prepared by dissolving metals or oxides in nitric acid. These metal-containing solutions are mixed to obtain desired compositions, then used to create UV-curable resins by blending with crosslinkers (e.g., poly(ethylene glycol) diacrylate), photoinitiators (e.g., lithium phenyl-2,4,6-trimethyl benzoyl phosphinate), and UV-blockers (e.g., tartrazine). Then, the metal-containing UV-curable resin is 3D printed by an LCD 3D printer. The printed resin is thermally converted to metals/alloys at 600° C. to 900° C. in an inert atmosphere or reducing atmosphere (e.g., ammonia and hydrogen) to accelerate the reduction process to metals/alloys. The obtained 3D structured object is composed of copper, copper alloys, copper-based oxides, or a combination of these.

### Composite Metal-Containing Precursor, Net-Shape Manufacturing, and Conversion

Net-shape manufacturing is a key technology to create desired shapes with controlled microstructure and materials. One of the emerging technologies in net-shape manufacturing is AM, which creates three-dimensionally designed architectures in an additive manner. Additive manufacturing of metal and ceramic-based materials attracts interest because optimized structures with desired properties can be created, which may not be feasible with traditional processes where material selection is limited to those materials that can undergo machining or metalworking processes.

State-of-the-art AM technologies of hard materials are mainly separated into two methods. Namely, consolidating hard material powder directly by locally applying energy (e.g., heat from a laser) and 3D structuring hard material particles or precursors, such as in the form of oxides or ions, in a soft-material matrix by continuous extrusion or 2D patterning. The second method is relatively low cost compared with the first method; however, the process of removing non-metal matrix and resultant shrinkage may distort the designed 3D structure. In addition, the current conversion or removing process relies on a thermal process, which is generally uncontrollable, making it challenging to create exotic materials that are non-equilibrium materials, such as amorphous materials.

To overcome these limitations, methods that can create net-shaped metals, ceramics, or their composites are disclosed here. Starting from slurry composed of metal or oxide powder in metal-ion containing liquid solution, which turns into a 3D architected precursor in solid form, then converting the solid form by a controllable and low energy method, provides significant advantages over traditional approaches.

This method involves (1) incorporating metals, ceramics, carbon, and/or their precursors as liquids or solids into metal-containing resin or a blank organic resin, (2) net-shape manufacturing of those materials by additive manufacturing, injection molding, or casting, (3) swelling metal ions into the resin, and (4) converting the materials created in steps (2) and (3) to the desired final products. In an embodiment, step (3) may be omitted or conducted simultaneously with step (4).

Precursor materials produced through steps (1)-(3) are composed of metal-ion containing resin as matrix and powder additives. The presence of hard material powder in net-shaped precursor material decreases thermal shrinkage compared with the conversion process from resin without hard material additives. In addition, utilizing metal-ion containing resin with materials that cause combustion synthesis (e.g., metal nitrate), electrochemical reduction, or photoreduction processes enables low temperature conversion (or rapid heating and cooling locally), leading to maintained microstructure of used powders such as amorphous materials. The metal ion can be supplied through a metal salt dissolved in liquid solution to the net-shaped precursor during the conversion process. The conversion process is selected from the group consisting of thermal conversion with an external heat source (e.g., furnace), microwave-derived thermal conversion, combustion synthesis-inducing thermal conversion, electrochemical reduction, photochemical synthesis, and combinations thereof.

Microwave-derived thermal conversion is advantageous because it achieves rapid heating with limited energy input, expedites manufacturing relative to process that use traditional heating methods, and promotes nucleation that leads to nano-or micro-structured final products.

Electrochemical conversion is also advantageous because metal-containing products can be obtained in various forms. For example, one product may contain metal particles dispersed throughout a resin matrix, where the metal has been produced via electrochemical reduction of a metal oxide. The resin containing metal particles may itself be the final product or it may be thermally treated to remove the resin leaving only metal or metal carbide as the final product.

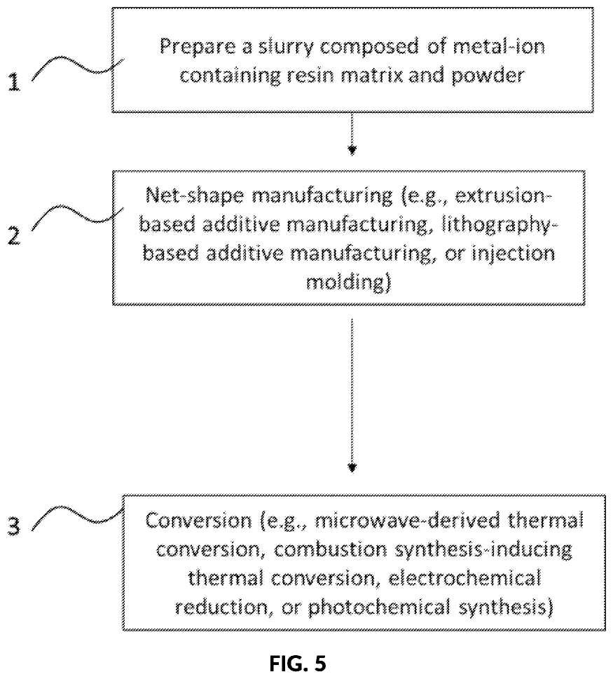

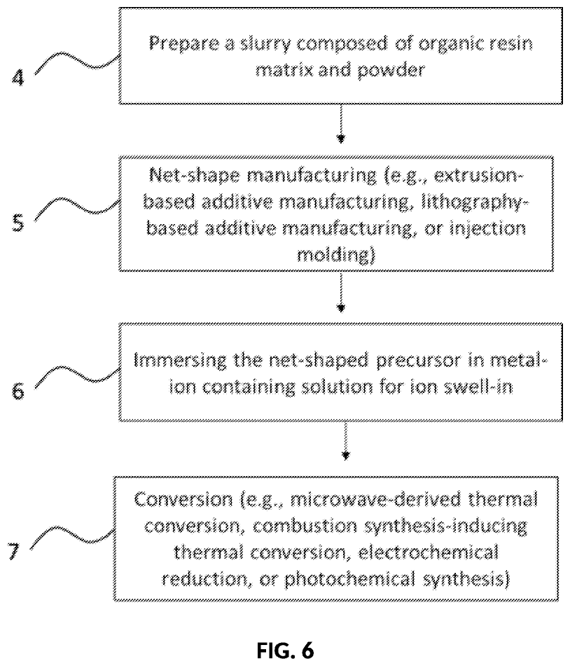

Processes starting from a slurry comprising metal-ion containing resin and a slurry comprising organic resin are summarized respectively in FIGS. 5 and 6.

Examples of composite metal-containing precursors, net-shape manufacturing and conversion follow. These Examples are for illustrative purposes only and are not intended to limit the invention.

### EXAMPLE 9

This Example illustrates creating net-shaped silver or silver alloy from a slurry of metal nitrate-dissolving resin and silver particles through net-shape manufacturing of the slurry and combustion synthesis-derived rapid thermal conversion.

A silver-ion containing aqueous resin is prepared by mixing crosslinkers (e.g., poly(ethylene glycol) diacrylate), photoinitiators (e.g., lithium phenyl-2,4,6-trimethyl benzoyl phosphinate), UV-blockers (e.g.,tartrazine), water, and silver nitrate. Silver ion may be incorporated by dissolving silver scraps into a nitric acid solution. Then, the silver-ion containing resin is mixed with silver particles. The prepared slurry undergoes net-shaped manufacturing including a lithography-based 3D print (e.g., LCD 3D print), extrusion-based 3D printing, or injection molding. The shaped slurry is solidified by UV light. The combination of slurry compositions and solidification-inducing processes may be applied to other types of resin (e.g., thermoset or thermoplastic) and heat. The net-shaped silver precursor is then heated to the temperature that induces combustion synthesis of metal nitrate, and the resultant rapid heating and cooling process may complete the conversion process to metal at significantly lower temperatures than traditional sintering temperatures. The type and concentration of metal nitrate may be selected depending on the desired silver alloy composition. The metal formation from metal nitrate resin and the presence of metal powder enables lower thermal shrinkage than either the thermal conversion process from metal-ion based resin or sintering of metal powder. Annealing may be carried out to homogenize alloy compositions or decrease porosity.

### EXAMPLE 10

This Example illustrates creating net-shaped alloys or metal-matrix composites from a slurry of metal nitrate-dissolving resin and metal particles through net-shape manufacturing of the slurry and electrochemical reduction with a simultaneous ion swell-in process.

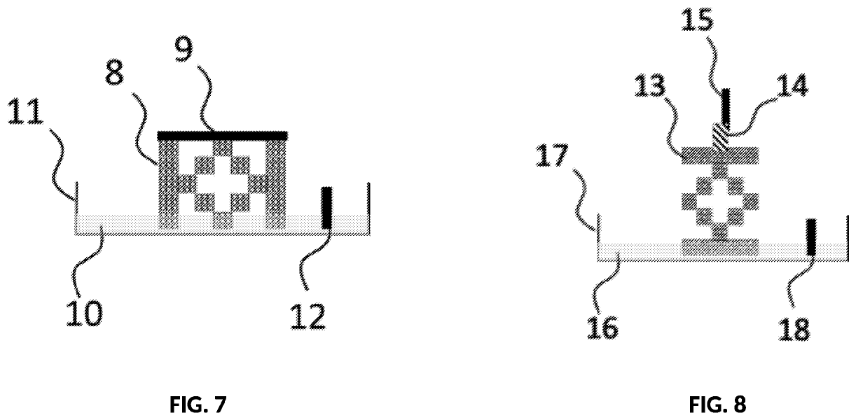

An aqueous resin is prepared by mixing crosslinkers (e.g., poly(ethylene glycol) diacrylate), photoinitiators (e.g., lithium phenyl-2,4,6-trimethyl benzoyl phosphinate), UV-blockers (e.g., tartrazine), and water. Metal salt (e.g., silver nitrate) may be dissolved during this process. Then, the metal-ion containing resin is mixed with metal or alloy particles. The prepared slurry undergoes net-shaped manufacturing including a lithography-based 3D print (e.g., LCD 3D print), extrusion-based 3D printing, or injection molding. The shaped slurry is solidified by UV light. The combination of slurry compositions and solidification-inducing processes may be applied to other types of resin (e.g., thermoset or thermoplastic) and heat. If metal salt is not dissolved, the net-shaped resin may be immersed for an ion swelling-in process. Then, the net-shaped metal ion containing precursor undergoes electrochemical reduction from a contacted cathode simultaneously supplying metal ions to the net-shaped resin by partially immersing it into metal ion-containing solution (i.e., simultaneous swell-in process). Alternatively, the net-shaped metal-ion containing precursor contains a sacrificial portion which will be removed after the electrochemical reduction step to enable electrochemical reduction throughout the final product structure. The position of contact of anode to the resin and the resin to the solution may be adjusted to achieve homogeneous electrochemical reduction. The anode is inserted into the metal ion-containing solution. This enables low temperature synthesis and near-zero shrinkage during conversion. FIGS. 6, 7 and 8 illustrate the electrochemical reduction process with simultaneous ion swell-in. As shown in FIG. 7, a container 11 of metal ion-containing solution 10 holds a net-shaped precursor 8 in contact with a cathode 9. A corresponding anode 12 is immersed in the solution 10. As shown in FIG. 8, a container 17 of metal ion-containing solution 16 holds a net-shaped precursor 13 with sacrificial precursor 14 in contact with a cathode 15. A corresponding anode 18 is immersed in the solution 10. The contact of the cathode 15 to the precursor 13 or 14 and contact position of precursor 13 to the solution 16 may be adjusted. If the incorporated metal or alloy particles are in a non-equilibrium state, this process effectively maintains the state during the conversion process, which is not feasible with a thermal conversion process. A post-annealing process may be carried out to homogenize alloy compositions, if desired.

Further, an electrical gradient may be established during the process of electrochemical reduction which, in combination with controlling the level of immersion of the net-shaped resin into the metal ion-containing solution, may be used to establish a metal concentration gradient along at least one dimension of a net-shaped resin and related final product.

Although the Examples disclosed above relate to net-shaped precursors, those of skill in the art will appreciate that precursors of other shapes may be advantageously formed by and subjected to the disclosed methods.

### REFERENCES

Narita, K., Citrin, M. A., Yang, H., Xia, X. & Greer, J. R. 3D architected carbon electrodes for energy storage. Adv. Energy Mater. 11, 2002637 (2021).
Haghdadi, N., Laleh, M., Moyle, M. & Primig, S. Additive manufacturing of steels: a review of achievements and challenges. J. Mater. Sci. 56, 64-107 (2021).
Pelz, J. S., Ku, N., Meyers, M. A. & Vargas-Gonzalez, L. R. Additive manufacturing of structural ceramics: a historical perspective. Journal of Materials Research and Technology 15, 670-695 (2021).
Gross, A. F., Jacobsen, A. J. & Cumberland, R. Ceramic microtruss. U.S. Pat. No. 8,435,438 (2013).
Chapiro, M. R., Delay, M. J., Dunn, R. C. & Zilar, D. M. Additive manufacturing of composite materials. U.S. Pat. No. 10,875,288 (2020).
Yee, D. W., Lifson, M. L., Edwards, B. W. & Greer, J. R. Additive Manufacturing of 3D-Architected Multifunctional Metal Oxides. Adv. Mater. 31, e1901345 (2019).
Vyatskikh, A., Kudo, A., Delalande, S. & Greer, J. R. Additive manufacturing of polymer-derived titania for one-step solar water purification. Materials Today Communications 15, 288-293 (2018).
L. Wang, A. Kiziltas, D.F. Mielewski, E. C. Lee, D. J. Gardner, Closed-loop recycling of polyamide 12 powder from selective laser sintering into sustainable composites, J. Clean. Prod. 195 (2018) 765-772.
M. Snyder, J. Dunn, A. Kemmer, E. Gonzalez, Recycling materials in various environments including reduced gravity environments, U.S. Pat. No. 10,759,089 (2020).
Scrap metal recycling process, CN Pat. No. 102151685 (2011)
B. K. Reck, T. E. Graedel, Challenges in metal recycling, Science. 337 (2012) 690-695.
C. G. Lee, S.-J. Kim, T.-H. Lee, C.-S. Oh, Effects of Tramp Elements on Formability of Low-Carbon TRIP-aided Multiphase Cold-Rolled Steel Sheets, ISIJ Int. 4 (2004) 737-743.
K. Suzuki, S. Kumai, Y. Salto, T. Haga, High-speed twin-roll strip casting of Al-mg-Si alloys with high iron content, Mater. Trans. 46 (2005) 2602-2608.
Worsley, M. A., Campbell, P. G., Huoss, E. B., Oakdale, J. S., Spadaccini, C. M. & Hensleigh, R. U.S. Pat. No. 10,379,439 (2019)
Vyatskikh, A., Delalande, S. J. & Greer, J. R. US Pat. Pub. No. 20200073236 (Mar. 5, 2020)
Yee, D. W. L, Greer, J. R. Lifson, M. L. & Citrin, M. A. US Pat. Pub. No. 20200156035 (May 21, 2020), now U.S. Pat. No. 11,318,435 (May 3, 2022)
Saccone, M. A., Gallivan, R. A., Narita, K., Yee, D. W., Greer, J. R., “Additive Manufacturing of Micro-Architected Metals via Hydrogel Infusion,” Nature, 612, (Oct. 20, 2022), 685-692.
Bhattacharya, M. and Basak, T., “A review on the susceptor assisted microwave processing of materials,” Energy, 97, (Feb. 15, 2016), 306-338.

### STATEMENTS REGARDING INCORPORATION BY REFERENCE AND VARIATIONS

All references cited throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods and devices useful for the present methods and devices can include a large number of optional composition and processing elements and steps. All art-known functional equivalents of materials and methods are intended to be included in this disclosure. Nothing herein is to be construed as an admission that the invention is not entitled to antedate such disclosure by virtue of prior invention.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a molecule” Includes a plurality of such molecules and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”
Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described.
Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are Included in the description herein can be excluded from the claims herein.
As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements, limitation or limitations which is/are not specifically disclosed herein.

1. A resin for additively manufacturing a final product comprising:
a crosslinker;
a photoinitiator;
a UV-blocker; and
a microwave susceptor selected from the group consisting of a metal, a metal oxide, a metal carbide, a metal nitride, carbon and combinations thereof,
wherein the final product consists of an inorganic material.

2. The resin of claim 1, wherein the crosslinker is selected from the group consisting of acrylate monomer, an acrylate oligomer, a methacrylate monomer, a methacrylate monomer, a thiol monomer, a thiol oligomer, an alkene monomer, an alkene oligomer, an alkyne monomer, an alkyne oligomer, an epoxy monomer, an epoxy oligomer, an epoxy acrylate-based monomer, and an epoxy-acrylate-based oligomer.

3. The resin of claim 1, where in the crosslinker is selected from the group consisting of acrylic polymers, ether polymers, fluorocarbon polymers, polystyrene polymers, poly(vinyl chloride) polymers, poly(N-vinylpyrrolidone) polymers, and combinations thereof.

4. The resin of claim 1, wherein the crosslinker is selected from the group consisting of poly(ethylene glycol) diacrylate, 1,3,5-triallyl-1,3,5-triazine-2,4,6(1H,3H,5H)-trione, and combinations thereof.

5. The resin of claim 1 further comprising a reactive diluent selected from the group consisting of acrylamide, acrylic acid, diurethane dimethacrylate, 2-hydroxypropane-1,3-diyl bis(2-methylacrylate), vinyl acetate, poly ethylene glycol monoacrylate and methyl methacrylate.

6. The resin of claim 1 further comprising at least two immiscible solvents formed into an emulsion.

7. The resin of claim 1, wherein the crosslinker comprises a carboxyl acid moiety, an amide moiety, an amine moiety, an aldehyde moiety, a ketone moiety, an ester moiety, a thiol moiety, an alkyl halide moiety, an alkoxy moiety, a hydroxyl moiety, or a phenyl moiety.

8. The resin of claim 1, wherein the photoinitiator is selected from the group consisting of lithium phenyl-2,4,6-trimethyl benzoyl phosphinate, 2,4,6-trimethylbenzoyl-diphenylphosphineoxide, 2,2-dimethoxy-1,2-diphenyl-ethan-1-one, 1-hydroxy-cyclohexyl-phenyl-ketone, benzophenone, 2-hydroxy-2-methyl-1-phenyl-1-propanone, 2-hydroxy-1-[4-(2-hydroxyethoxy)phenyl]-2-methyl-1-propanone, methylbenzoylformate oxy-phenyl-acetic acid 2-[2 oxo-2 phenyl-acetoxy-ethoxy]-ethyl ester, oxy-phenyl-acetic 2-[2-hydroxy-ethoxy]-ethyl ester, alpha, alpha-dimethoxy-alpha-phenylacetophenone, 2-benzyl-2-(dimethylamino)-1-[4-(4-morpholinyl) phenyl]-1-butanone, 2-methyl-1-[4-(methylthio) phenyl]-2-(4-morpholinyl)-1-propanone, diphenyl (2,4,6-trimethylbenzoyl)-phosphine oxide, phosphine oxide, phenyl bis (2,4,6-trimethyl benzoyl), bis (eta 5-2,4-cyclopentadien-1-yl)bis [2,6-difluoro-3-(1H-pyrrol-1-yl) phenyl]titanium iodonium, (4-methylphenyl) [4-(2-methylpropyl), phenyl]-,hexafluorophosphate(1-), 2,2-dimethoxy-1,2-diphenylethan-1-one, isopropyl thioxanthone, 2-ethylhexyl-(4-N,N-dimethyl amino)benzoate, ethyl-4-(dimethylamino)benzoate, 2-dimethylamino-2-(4-methyl-benzyl)-1-(4-morpholin-4-yl-phenyl)-butan-1-one, azobisisobutyronitrile, benzoyl peroxide and combinations thereof.

9. The resin of claim 1, wherein the UV-blocker is selected from the group consisting of tartrazine, benzotriazoles, benzophenones, triazines, 1-(phenyldiazenyl)naphthalen-2-ol and combinations thereof.

10. (canceled)

11. The resin of claim 1, further comprising a metal complex or a metal salt.

12. The resin of claim 11, wherein the metal salt or the metal complex is a metal nitrate, a metal nitrite, a metal hydroxide, a metal chloride, a metal sulfate, a metal carbonate, a metal bicarbonate, a metal acetate, a metal fluoride, a metal bromide, a metal iodide, a metal phosphate, a metal chromate, a metal cyanide, a metal chlorate, a metal perchlorate, a metal benzoate, a metal borohydride, a metal acrylate and/or a metal sulfide.

13. An additive manufacturing and thermal conversion process comprising:
additively manufacturing a 3D structure by photopolymerizing the resin of claim 1; and
thermally converting the 3D structure into a final product via microwave heating, wherein the final product consists of an inorganic material.

14. The process of claim 13 further comprising swelling the 3D structure using an aqueous metal salt solution to form a metal-containing hydrogel.

15. The process of claim 13, wherein the 3D structure is a microwave susceptor-containing organogel or a microwave susceptor-containing hydrogel.

16. The process of claim 13 further comprising electrochemically introducing metals into the 3D structure.

17. The process of claim 13, further comprising coating a glazing material on the 3D structure prior to thermally converting.

18. The process of claim 17, wherein the glazing material comprises a preceramic polymer, a metal oxide particle-containing fluid, or a glass precursor.

19. The process of claim 13 further comprising exposing the 3D structure to a reducing atmosphere or an oxidizing atmosphere during the step of thermally converting.

20. The process of claim 13, wherein the final product comprises nano-grains, micro-grains or twinning.

21. The resin of claim 1, wherein the inorganic material is selected from the group consisting of a metal, an alloy, an oxide, a nitride, a carbide, a ceramic and composites thereof.
